(19) United States
(12) Patent Application Publication
(10) Pub. No.: US 2004/0099479 A1
(43) Pub. Date: May 27, 2004

(54) Foldable support assembly

(75) Inventor: Sami Sagol, Ramat Hasharon (IL)

Correspondence Address: BROWDY AND NEIMARK, P.L.L.C., 624 NINTH STREET, NW, SUITE 300, WASHINGTON, DC, 20001-5303, US

(73) Assignee: Keter Plastic Ltd., Kerzelyia (IL)

(21) Appl. No.: 10/305,387

(22) Filed: Nov. 27, 2002

(51) Int. Cl. E06C 1/00

(52) U.S. Cl. 182/165

(57) ABSTRACT

A foldable support assembly, that may be for example, a folding chair, ladder or step-stool. The assembly comprises a first leg assembly and a second leg assembly that are hinged to each other near their tops so as to form a variable angle between them;. The second leg assembly comprises first and second legs, each leg being provided with a cam pin that projects from the leg. A support surface, upon which a load is to be placed, has a first edge, a second edge and two lateral sides. Each lateral side has an integral cam track configured to receive a cam pin projecting from one of the legs. The support surface is hinged at its first edge to the first leg assembly and supported at its second edge by the cam pins received in the cam tracks. Movement of the cam pins in the cam tracks during variation of the angle between the leg assemblies is coupled to rotation of the support surface.

### FIELD OF THE INVENTION

This invention relates generally to foldable assemblies for supporting loads such as a foldable chair, ladder, or step stool.

### BACKGROUND OF THE INVENTION

Many foldable assemblies for supporting a load comprise a front leg assembly hinged near its top to a rear leg assembly. Such foldable support assemblies include folding chairs, ladders and step stools. The support assembly has an unfolded conformation in which it is used, in which the front and rear leg assemblies form an angle having the hinge at its vertex, so as to form an inverted V-formation. In the unfolded conformation, the support assembly is free standing. The support assembly also has a folded conformation in which the front and rear leg assemblies are essentially parallel to each other. This allows compact storage of the support assembly when not in use.

These support assemblies also comprise a support surface upon which a load is placed. The load may be a person standing or sitting on the support surface. When the support assembly is in the unfolded conformation, the support surface has an essentially horizontal orientation so as to be able to support the load. When the support assembly is in the folded conformation, the support surface is parallel to the front and rear leg assemblies, and therefore has an essentially vertical orientation. Unfolding the support assembly thus requires two actions: increasing the angle between the front and rear leg assemblies, and rotating the support surface from its vertical orientation to its horizontal orientation. Folding the support assembly requires the reverse of these two actions.

In many foldable support assemblies, the support surface and the leg assemblies are associated with each other in such a fashion so that when a user performs one of the two actions required to fold or unfold the support assembly, the second action occurs simultaneously. For example, a commercially available step stool has a support surface that is hinged near its front edge to the front leg assembly and is provided near its rear edge with pins that project into linear tracks formed in the corresponding rear legs. When the rear legs are folded in against the front legs, the pins ride in the rear leg tracks causing the support surface to rotate. As another example, rotation of the seat of a folding chair causes the front legs to fold against the rear legs.

### SUMMARY OF THE INVENTION

The present invention provides a support assembly, that may be, for example, a folding chair, a ladder, or a step stool. The support assembly has front and rear legs and a support surface configured to support a load that may be, for example, a person standing or sitting on the support surface. The support assembly has an unfolded conformation in which it is used in which the support surface is horizontal, and the front and rear legs form an angle so as to allow the support assembly to be free standing. The support assembly also has a folded conformation in which the support surface and the front and rear legs are essentially parallel to each other.

In accordance with the invention, the support surface is hinged on either side to the front legs. The hinge axle is close to the front edge of the of the support surface. The rear edge of the support surface is supported by cam pins that project from the rear legs into integral arcuate cam tracks provided on either side of the support surface. The cam tracks extend along the sides of the support surface from near the rear edge towards the front edge. In the unfolded conformation, the cam pins are located in the cam tracks far from the hinge axles. In the folded conformation, the cam pins are near the hinge angles.

When the support assembly in the unfolded conformation is to be folded, the cam pins are moved in the cam tracks towards the hinge axles. This may occur by decreasing the angle between the front and rear leg assemblies. As the angle between the front and rear legs decreases, the distance between the cam pins and the hinge axles decreases causing the support surface to rotate from its horizontal orientation to its vertical orientation. Alternatively, the cam pins may be made to move towards the hinge axles by rotating the support surface from its horizontal orientation to its vertical orientation. As the support surface is rotated, the distance between the cam pins and the hinge axles decreases, causing the angle between the front and rear legs to decrease.

When the support assembly in the folded conformation is to be unfolded, the cam pins are moved in the cam tracks away from the hinge axles. This may occur by increasing the angle between the front and rear leg assemblies. As the angle between the front and rear legs increases, the distance between the cam pins and the hinge axles increases causing the support surface to rotate from its vertical orientation to its horizontal orientation. Alternatively, the cam pins may be made to move towards the hinge axles by rotating the support surface from its vertical orientation to its horizontal orientation. As the support surface is rotated, the distance between the cam pins and the hinge axles increases, causing the angle between the front and rear legs to increase.

The invention thus provides a foldable support assembly, comprising:

(a) a first leg assembly;

(b) a second leg assembly comprising first and second legs, each leg being provided with a cam pin that projects from the leg, the first and second leg assemblies being hinged to each other near their tops so as to form a variable angle between them; and

(c) a support surface having a first edge, a second edge and two lateral sides, each lateral side having an integral cam track configured to receive a cam pin projecting from one of the legs, the support surface being hinged at its first edge to the first leg assembly and supported at its second edge by the cam pins received in the cam tracks;

wherein movement of the cam pins in the cam tracks during variation of the angle between the leg assemblies is coupled to rotation of the support surface.

### BRIEF DESCRIPTION OF THE DRAWINGS

For a better understanding of the invention, reference is made to the annexed drawings wherein:

FIG. 1 is a perspective view of a support assembly in accordance with one embodiment of the invention;

FIG. 2 is a side view of the assembly in its unfolded conformation in which it is free-standing;

FIG. 3 is a perspective view of the support surface of the support assembly;

FIG. 4 shows the support assembly in its conformation, and FIG. 5 is a perspective view of an embodiment of the invention provided with a safety handle bar.

### DETAILED DESCRIPTION OF THE INVENTION

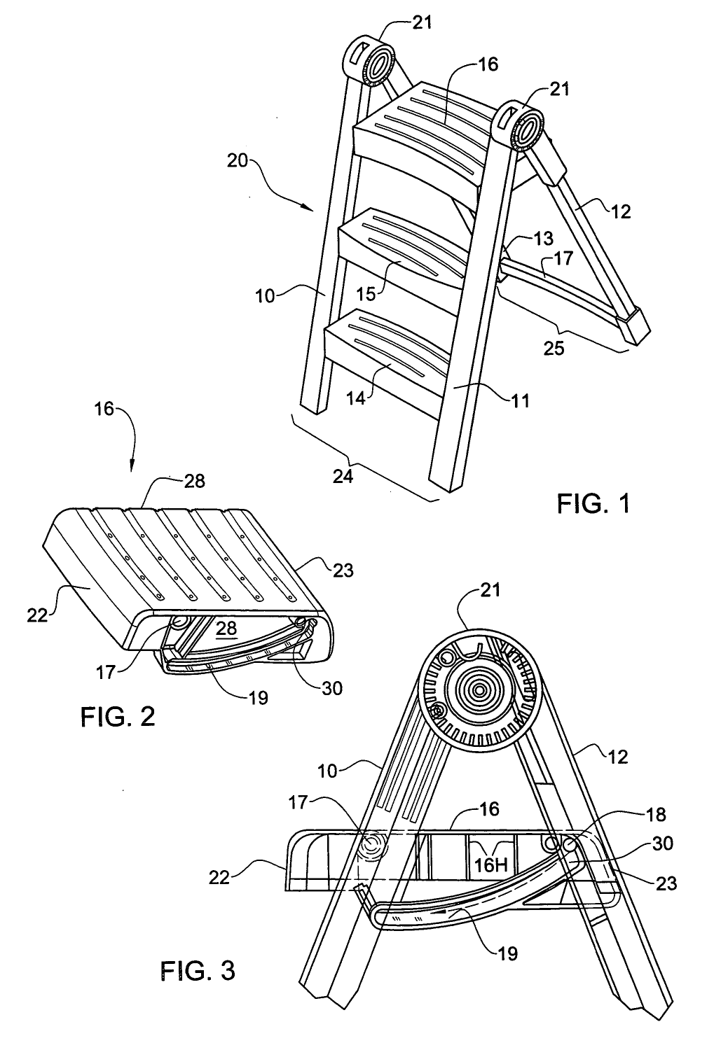

FIG. 1 shows a support assembly 20 having a front leg assembly 24 comprising a pair of parallel legs 10 and 11, and a rear leg assembly 25, comprising a rear pair of parallel legs 12 and 13. The front and rear leg assemblies are hinged to each other at their tops by a pair of hinges 21. The legs of the assembly may be molded of high-strength synthetic plastic material, such as polycarbonate or polypopylene, or the legs may be fabricated of a lightweight, high-strength metal, such as aluminum. Alternatively, the legs may be formed of a metal-plastic composite. The front leg assembly 24 may also include steps 14 and 15 that bridge front legs 10 and 11. The rear leg assembly 25 may include a crosspiece 17 bridging the lower end of rear legs 12 and 13.

The support assembly 20 also includes a support surface 16 upon which a load is to be placed. The load may be, for example, a person sitting or standing on the support surface 16. As shown in FIG. 2, the support surface 16, is provided with an underlying reinforcing honeycomb 16H, in order to allow it to support a heavy load without buckling.

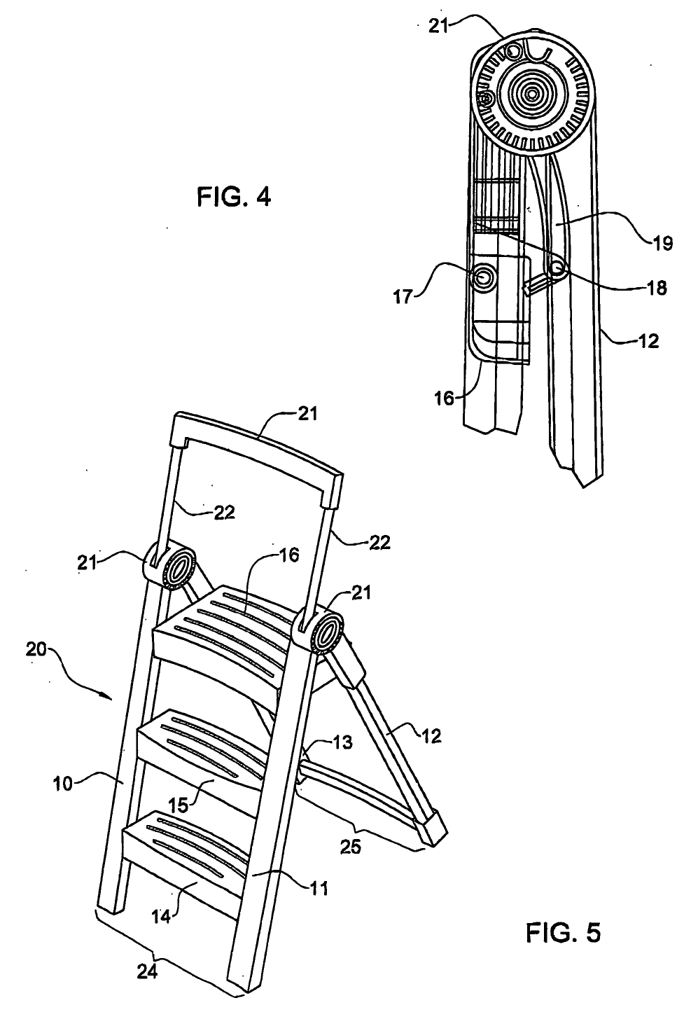

The support surface 16 has a front edge 22 and a rear edge 23 and lateral sides 28. In accordance with the invention, the support surface 16 is hinged on either side to front legs 10 and 11 by hinges that include a hinge axle 17. The hinge axle 17 is close to the front edge 22 of the of the support surface 16. The rear edge 23 of the support surface 16 is supported by cam pins 18 that project from rear legs 12 and 13 into respective integral arcuate cam tracks 19 provided on either side 28 of the support surface 16. . Cam track 19, as best seen in FIG. 3, thus extends along the sides of the support surface 16 from near the rear edge 23 towards the front edge 22.

When the support assembly 20 is in the unfolded conformation, as shown in FIG. 2, the front and rear leg assemblies form an angle with the vertex at the hinges. The support surface 16 is in its horizontal orientation and is supported at its front and rear corners by hinge axles 17 and cam pins 28, respectively.

When the support assembly 20 in the unfolded conformation shown in FIGS. 1 and 2 is to be folded, the angle between the front and rear leg assemblies is decreased. As the angle between the front and rear leg assemblies decreases, cam pins 18 traverse the arcuate cam track 19 on opposite sides 28 of the support surface 16. As the distance between the cam pins 18 and the hinge axles 17 decreases, the support surface rotates from its horizontal orientation shown in FIG. 2 to its vertical orientation shown in FIG. 4. It will be seen in FIG. 4, that in the folded conformation, cam pin 18 is below hinge axle 17 at the front end and the support surface 16.

The cam tracks 19 may terminate in a latch section 30 which is essentially perpendicular to the remainder of the cam track 19. As shown in FIG. 2, when the support assembly is in the unfolded conformation, the cam pins 18 are located in the latch section 30. This prevents the support assembly from inadvertently folding when in use. In order to fold the support assembly, the rear edge 23 of the support surface must be slightly raised in order to remove the cam pin 18 from the latch section to the arcuate section.

As shown in FIG. 5, the support assembly 20 may optionally have a safety handle bar 21 that can be grasped by a user when using the support assembly. Safety bar 21 is supported by a pair of posts 22 and 23 which are anchored in the front legs 10 and 11, respectively. The posts may be telescoped into the legs, making it possible to adjust the height of the safety bar.

While there has been shown preferred embodiments of a support assembly in accordance with the invention, it is to be understood that many changes may be made therein without departing from the spirit of the invention.

1. A foldable support assembly, comprising:
(a) a first leg assembly;
(b) a second leg assembly comprising first and second legs, each leg being provided with a cam pin that projects from the leg, the first and second leg assemblies being hinged to each other near their tops so as to form a variable angle between them; and
(c) a support surface having a first edge, a second edge and two lateral sides, each lateral side having an integral cam track configured to receive a cam pin projecting from one of the legs, the support surface being hinged at its first edge to the first leg assembly and supported at its second edge by the cam pins received in the cam tracks;
wherein movement of the cam pins in the cam tracks during variation of the angle between the leg assemblies is coupled to rotation of the support surface.

2. The support assembly of claim 1 being a folding chair, a ladder or a step stool.

3. The support assembly of any one of the previous claims, wherein the cam tracks are arcuate.

4. The support assembly of any one of the previous claims the cam track contains a latch section such that when the cam pin is in the latch section, the angle between the first and second leg assemblies is fixed.

5. An assembly as in claim 4, in which the track has an arcuate form to cause the uppermost step to fold upwardly as the legs are folded together and the cam pin then traverses the track.

6. An assembly as set forth in claim 1, in which the legs are molded of synthetic plastic.

7. An assembly as in claim 1, in which the legs are fabricated of aluminum.

8. An assembly as in claim 1, in which the legs are a metal-plastic composite.

9. An assembly as in claim 1, further including a safety handle bar supported by posts anchored in a leg assembly.

10. An assembly as in claim 10, in which the posts are telescoped in a leg assembly so the height of the bar is adjustable.
